(19) United States
(12) Patent Application Publication
(10) Pub. No.: US 2005/0104443 A1
(43) Pub. Date: May 19, 2005

(54) Master cylinder with a braking stroke simulator

(76) Inventor: Akihito Kusano, Toyota city (JP)

Correspondence Address: BURNS DOANE SWECKER & MATHIS L L P, POST OFFICE BOX 1404, ALEXANDRIA, VA, 22313-1404, US

(21) Appl. No.: 10/976,921

(22) Filed: Nov. 1, 2004

(30) Foreign Application Priority Data
Nov. 17, 2003 (JP) 2003-386663

(51) Int. Cl. B60T 13/74

(52) U.S. Cl. 303/113.4; 303/115.1; 303/3; 303/5; 303/11

(57) ABSTRACT

A piston member is slidably accommodated in a housing for defining a master pressure chamber. A simulator piston is provided for defining a simulator chamber and moving in response to operation of a brake pedal. The simulator chamber is communicated with an atmospheric pressure chamber when the piston member is placed in an initial position thereof, and the communication between the master chamber and the atmospheric pressure chamber is blocked when the piston member is advanced from the initial position thereof by a first stroke or more. Furthermore, the communication between the simulator chamber and the atmospheric pressure chamber is blocked when the piston member is advanced from the initial position by a second stroke, which is set to be greater than the first stroke, or more. And, a blocking member is provided for restricting the simulator piston to be retracted up to a position thereof which is placed relative to the piston member when the brake pedal is inoperative.

This application claims priority under 35 U.S.C. Sec. 119 to No. 2003-386663 filed in Japan on Nov. 17, 2003, the entire content of which is herein incorporated by reference.

### BACKGROUND OF THE INVENTION

1. Field of the Invention

The present invention relates to a master cylinder for use in a hydraulic brake apparatus of a vehicle, and more particularly to a master cylinder with a braking stroke simulator operated in response to operation of a manually operated braking member.

2. Description of the Related Arts

Heretofore, there is known various hydraulic brake apparatuses each having a master cylinder with a braking stroke simulator. Among them, such an apparatus as discussed below has been disclosed in Japanese Patent Laid-open publication No. 11-59349. According to the apparatus, when a pressure control device including a pressure source is normal, the hydraulic pressure generated by the pressure source is controlled by the pressure control device in response to operation of a manually operated braking member to be supplied into wheel brake cylinders, with the communication between the master cylinder and the wheel brake cylinder being blocked. When the pressure control device has come to be abnormal, the master cylinder is communicated with the wheel brake cylinder, to discharge the hydraulic pressure into the wheel brake cylinder in response to operational force of the manually operated braking member.

In general, the stroke simulator is adapted to provide the manually operated braking member with a stroke in response to the braking operation force, when the pressure control device is normal, i.e., when the communication between the master cylinder and the wheel brake cylinder has been blocked. And, according to the hydraulic brake apparatus as disclosed in the Japanese Patent Laid-open publication, the stroke simulator is disposed between the manually operated braking member and a master piston. In view of the fact that it is required to provide a large stroke of a brake pedal in response to a stroke of the stroke simulator, when the pressure control device is abnormal, i.e., when the hydraulic pressure is supplied from the master cylinder to the wheel brake cylinder, there is provided cut-off means for blocking the communication between a simulator chamber and an atmospheric pressure chamber in response to movement of the master piston. As for the cut-off means, there are provided a sleeve partially in contact with an inner surface of a cylinder body, and a seal member fixed to the master piston, whereby the stroke of the stroke simulator may be restricted, when the hydraulic pressure is supplied from the master cylinder to the wheel brake cylinder.

According to the hydraulic brake apparatus as disclosed in the Japanese Patent Laid-open publication, however, if the pressure control device became abnormal, for example, and the manually operated braking member was released rapidly from a state where the master piston was advanced to be in a braking operation, only a simulator piston could be retracted in advance. In this case, the master piston may not be retracted, with the simulator chamber completely closed. According to the apparatus as disclosed in the Japanese Patent Laid-open publication, therefore, a port has been provided on the simulator piston to communicate the simulator chamber with another atmospheric pressure chamber at its rear end position, which costs much.

### SUMMARY OF THE INVENTION

Accordingly, it is an object of the present invention to provide a master cylinder having a braking stroke simulator used for a component of a hydraulic brake apparatus for a vehicle, which is capable of restricting a stroke of a manually operated braking member when the hydraulic pressure is supplied from a master pressure chamber to wheel brake cylinders, and opening the master pressure chamber when the braking operation is released.

In order to accomplish the above and other objects, the master cylinder is provided with a piston member which is slidably accommodated in a cylinder bore of a cylinder housing for defining a master pressure chamber in front of the piston member, and a stroke simulator which has a simulator piston for defining a simulator chamber in front of the simulator piston and moving back and forth in response to operation of a manually operated braking member, to communicate the master pressure chamber with an atmospheric pressure chamber when the piston member is placed in an initial position thereof, and block the communication between the master pressure chamber and the atmospheric pressure chamber when the piston member is advanced from the initial position thereof by a first stroke or more, and which has an elastic member for applying a stroke of the simulator piston in response to braking operation force of the manually operated braking member. The stroke simulator is adapted to transmit the braking operation force of the manually operated braking member to the piston member, through the simulator piston and the elastic member. Furthermore, a communication control device is provided for communicating the simulator chamber with the atmospheric pressure chamber when the piston member is placed in an initial position thereof, and blocking the communication between the simulator chamber and the atmospheric pressure chamber when the piston member is advanced from the initial position thereof by a second stroke, which is set to be greater than the first stroke, or more. And, a restriction device is provided for restricting the simulator piston to be retracted up to a position thereof which is placed relative to the piston member when the manually operated braking member is inoperative.

Preferably, the piston member includes a master piston which is slidably received in the cylinder bore for defining the master pressure chamber in front of the master piston, and the master piston has a recess which is formed to be opened rearward of the master piston, and in which the elastic member and the simulator piston are accommodated.

The restriction device as described above may include a blocking member fixed on a rear end portion of the recess of the master piston to prevent the simulator piston from being moved rearward beyond the blocking member. The blocking member may be a ring member which is formed in C-shape, and which is fitted into an annular groove formed on an inner peripheral surface of the rear end portion of the recess of the master piston. The blocking member may be an annular plug which is screwed into the rear end portion of the recess of the master piston, or an annular stopper which is pressed into the rear end portion of the recess of the master piston. Or, the blocking member may be a caulking portion which is formed on the rear end portion of the recess of the master piston.

In the master cylinder with the braking stroke simulator, the piston member may include a master piston which is slidably received in the cylinder bore for defining the master pressure chamber in front of the master piston, and an auxiliary piston which is placed to be in contact with a rear end face of the master piston, and which is formed with a recess being opened rearward of the auxiliary piston, to accommodate therein the elastic member and the simulator piston. The communication control device is adapted to block the communication between the simulator chamber and the atmospheric pressure chamber when the auxiliary piston is advanced from the initial position thereof by the second stroke or more, and the restriction device is adapted to restrict the simulator piston to be retracted up to a position thereof which is placed relative to the auxiliary piston when the manually operated braking member is inoperative.

The restriction device as described above may include a blocking member fixed on a rear end portion of the recess of the auxiliary piston to prevent the simulator piston from being moved rearward beyond the blocking member. The blocking member may be a ring member which is formed in C-shape, and which is fitted into an annular groove formed on an inner peripheral surface of the rear end portion of the recess of the auxiliary piston. The blocking member may be an annular plug which is screwed into the rear end portion of the recess of the auxiliary piston, or an annular stopper which is pressed into the rear end portion of the recess of the auxiliary piston. Or, the blocking member may be a caulking portion which is formed on the rear end portion of the recess of the auxiliary piston.

### BRIEF DESCRIPTION OF THE DRAWINGS

The above stated object and following description will become readily apparent with reference to the accompanying drawings, wherein like reference numerals denote like elements, and in which:

FIG. 1 is a sectional view of a master cylinder with a braking stroke simulator according to an embodiment of the present invention;

FIG. 2 is a schematic block diagram of a hydraulic brake apparatus having a master cylinder with a braking stroke simulator according to an embodiment of the present invention;

FIG. 3 is a sectional view of a master cylinder with a braking stroke simulator according to another embodiment of the present invention;

FIG. 4 is a sectional view of a master cylinder with a braking stroke simulator according to a further embodiment of the present invention;

FIG. 5 is a plan view of a C-ring for use in an embodiment of the present invention;

FIG. 6 is a sectional view of a master cylinder, with an annular plug fitted into a recess formed in a rear end of a master piston, to act as a blocking member according to an embodiment of the present invention;

FIG. 7 is a sectional view of a master cylinder, with a caulking portion formed on a rear end portion of a master piston, to act as a blocking member according to an embodiment of the present invention; and

FIG. 8 is a cross sectional view of the caulking portion as shown in FIG. 7.

### DESCRIPTION OF THE PREFERRED EMBODIMENTS

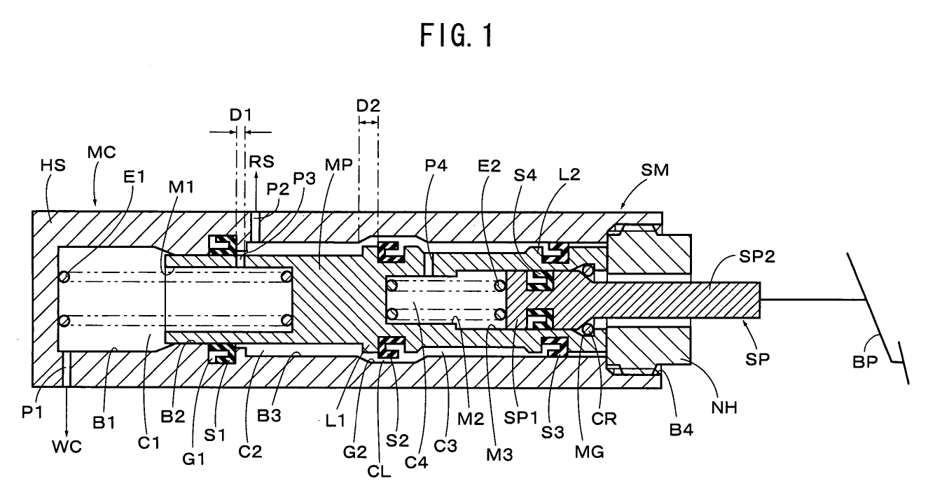

Referring to FIG. 1, there is illustrated a master cylinder MC with a stroke simulator SM formed in a body according to an embodiment of the present invention, which includes a master piston MP served as a piston member of the present invention and slidably accommodated in a cylinder housing HS, with a simulator piston SP slidably accommodated in the master piston MP. The housing HS is closed in its front end (leftward in FIG. 1) to be formed in a cylinder with a bottom, with a cylinder bore having a stepped bore of a recess B1, a small diameter bore B2 and a large diameter bore B3. At the rear end of the housing HS, there is formed an open end portion B4 with threaded grooves formed therein. On the inner surface of the small diameter bore B2, an annular groove G1 is formed for holding a seal member S1 having a cup-like cross section, whereas on the inner surface of the large diameter bore B3, there is formed an annular groove G2 having a certain width along the longitudinal axis of the bore B3. On the side wall of the housing HS, there are formed a port P1 opening into the recess B1, and a port P2 opening into the large diameter bore B3 near the small diameter bore B2. The housing HS may be made of a single metallic member, because those recess B1, small diameter bore B2, large diameter bore B3, open end portion B4, and annular grooves G1 and G2 can be formed by boring the housing HS along the longitudinal axis thereof.

As for the master piston MP, there are formed at its front end a recess M1 opening forward, and formed at its rear end a recess opening rearward, in the latter of which a cylinder bore is formed to provide a stepped bore of a small diameter bore M2 and a large diameter bore M3. On the inner surface of the large diameter bore M3 near the open end thereof, an annular groove MG is formed for holding a C-ring CR as described later. On the side wall of the master piston MP, there are formed a port P3 opening into the recess M1, and a port P4 opening into the small diameter bore M2. A land portion L1 is formed around the outer peripheral surface of a middle portion of the master piston MP, and a land portion L2 is formed around the outer surface of its rear portion, with annular grooves formed on their outer peripheral surfaces, to hold therein annular seal members S2 and S3 having cup-like cross sections, respectively.

The simulator piston SP has a large diameter piston portion SP1 to be slidably accommodated in the large diameter bore M3, and a small diameter axial portion SP2 extending rearward from the former. On the outer peripheral surface of the piston portion SP1, there is formed an annular groove for holding therein an annular seal member S4 having a cup-like cross section. The axial portion SP2 is connected to a brake pedal BP served as the manually operated braking member. The seal members S1 and S2 act as a check valve, respectively, to block the flow of brake fluid from the opened side of cup-like cross section to the closed side thereof, and allow the flow of brake fluid from the closed side to the opened side, so that the seal member S2 allows the flow of brake fluid from the front side (left side in FIG. 1) to the rear side, and blocks its reverse flow.

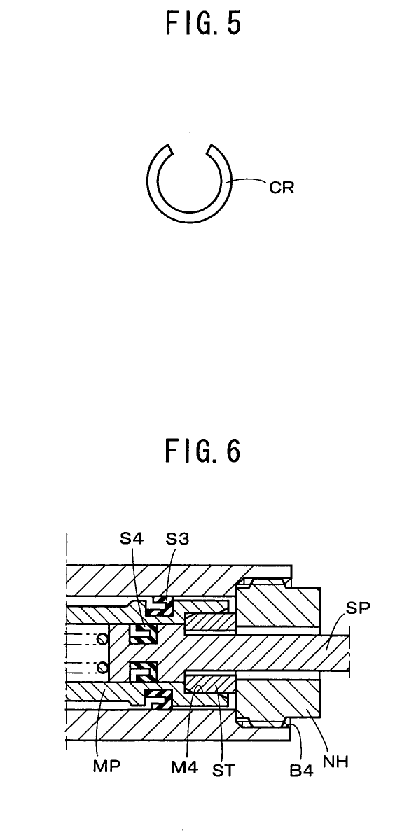

Next will be explained the parts as described above, according to an example of a sequence of steps for assembling them, and a device for restricting the retraction according to the present embodiment. At the outset, a compression spring E2 served as an elastic member for the simulator is received into the small diameter bore M2 and large diameter bore M3 of the master piston MP. Then, the simulator piston SP with the seal member S4 mounted thereon is fluid-tightly and slidably received into the large diameter bore M3 to define a simulator chamber C4 in front of the piston portion SP1. With the piston portion SP1 accommodated in the large diameter bore M3, fitted into the annular groove MG of the master piston MP is the C-ring CR, which acts as a blocking member served as a device for restricting the retraction according to the present invention, and which is formed in C-shape as shown in FIG. 5. The simulator piston SP is capable of being moved rearward by means of biasing force of the compression spring E2, until the rear end of the piston portion SP1 abuts on the C-ring CR, which prevents a further rearward movement of the piston portion SP1, whereby the rearmost end of the simulator piston SP relative to the master piston MP is defined. Then, the seal members S2 and S3 are-mounted on the land portions L1 and L2 of the master piston MP, respectively.

Next, the seal member S1 is fitted into the annular groove G1 of the housing HS, and a compression spring E1 served as a return spring is received in the recess B1 of the housing HS and the recess M1 of the master piston MP, and then the master piston MP is fitted into the small diameter bore B2 and large diameter bore B3. Consequently, the master piston MP is fluid-tightly and slidably accommodated in the small diameter bore B2 and large diameter bore B3, through the seal members S1 and S3, respectively. Thus, with the master piston MP accommodated in the small diameter bore B2 and large diameter bore B3 of the housing HS, screwed into the open end portion B4 of the housing HS is a nut-like stopper NH with threaded grooves formed on its outer peripheral surface, which prevents the master piston MP from being moved rearward against the biasing force of the compression spring E1, to act as the annular blocking member.

With those parts assembled as described above, the master pressure chamber C1 is defined in front of the master piston MP in the master cylinder MC, to be communicated with the wheel brake cylinder WC through the port P1 (via an electromagnetic switching valve NO as described hereinafter). An atmospheric pressure chamber C2 is formed between the seal members S1 and S2 held on the inner peripheral surface of the housing HS, and an annular chamber C3 is formed between the seal members S2 and S3, so that the atmospheric pressure chamber C2 is so constituted to be always communicated with an atmospheric pressure reservoir RS (hereinafter, simply referred to as a reservoir RS) through the port P2. When the master piston MP is placed in its initial position as shown in FIG. 1, therefore, the master pressure chamber C1 is communicated with the atmospheric pressure chamber C2 through the port P3, and finally communicated with the reservoir RS under the atmospheric pressure, through the port P2. On the contrary, when the master piston MP is advanced from its initial position by a first stroke (D1) and more, the opening area of the port P3 is closed by the seal member S1, thereby to block the communication between the master pressure chamber C1 and the atmospheric pressure chamber C2 (and the reservoir RS). At the same time, when the master piston MP is placed in its initial position as shown in FIG. 1, the atmospheric pressure chamber C2 is communicated with the annular chamber C3 through a clearance CL between the seal member S2 and the annular groove G2, and therefore the simulator chamber C4 is communicated with the annular chamber C3 and the atmospheric pressure chamber C2 through the port P4, whereby the simulator chamber C4 is communicated with the reservoir RS through the port P2. And, when the master piston MP is advanced from the initial position thereof by a second stroke (D2), which is greater than the first stroke (D1), or more, the communication between the annular chamber C3 (then, the simulator chamber C4) and the atmospheric pressure chamber C2 will be blocked by the seal member S2 and the inner surface of the large diameter bore B3. Thus, a communication control device according to the present invention is constituted.

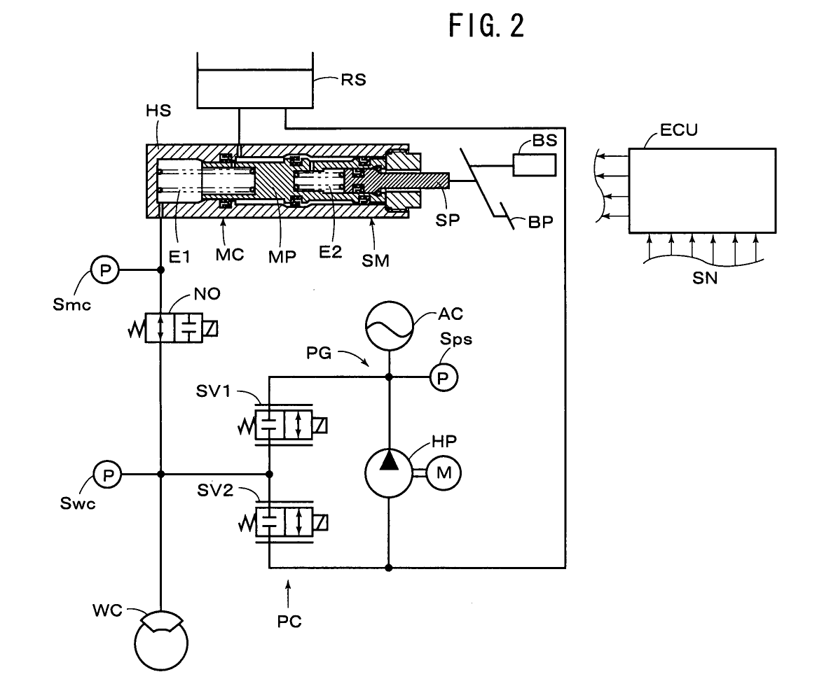

The master cylinder with the braking stroke simulator as described above is provided to constitute a hydraulic brake apparatus for a vehicle as shown in FIG. 2, wherein the master pressure chamber C1 of the master cylinder MC is connected to a wheel brake cylinder WC operatively mounted on each wheel of the vehicle through a normally open electromagnetic switching valve NO. And, a pressure source PG for generating a certain hydraulic pressure irrespective of the braking operation of the vehicle driver is connected to a hydraulic passage between the switching valve NO and the wheel brake cylinder WC.

According to the present embodiment, the pressure source PG includes an electric motor M controlled by an electronic control unit ECU, and a hydraulic pressure pump HP, which is driven by the electric motor M, and whose inlet is connected to the reservoir RS, and whose outlet is connected to an accumulator AC. According to the present embodiment, a pressure sensor Sps is connected to the outlet, and the detected pressure is monitored by the electronic control unit ECU. On the basis of the monitored result, the motor M is controlled by the electronic control unit ECU to keep the hydraulic pressure in the accumulator AC between predetermined upper and lower limits. The accumulator AC is connected to a hydraulic passage between the switching valve NO and the wheel brake cylinder WC, through a first linear solenoid valve SV1 of a normally closed type, to regulate the hydraulic pressure discharged from the pressure source PG and supply it to the wheel brake cylinder WC. Also, the reservoir RS is connected to the hydraulic passage between the switching valve NO and wheel brake cylinder WC, through a second linear solenoid valve SV2 of a normally closed type, to reduce the pressure in the wheel brake cylinder WC and regulate it. Accordingly, a pressure control device PC is formed by the pressure source PG, first and second linear solenoid valves SV1 and SV2, electronic control unit ECU, and sensors as described hereinafter.

According to the present embodiment, a pressure sensor Smc is disposed in a hydraulic passage between the master cylinder MC and the switching valve NO, and a pressure sensor Swc is disposed in a hydraulic passage between the switching valve NO and the wheel brake cylinder WC. On the brake pedal BP, a stroke sensor BS is operatively connected to detect its stroke. The signals detected by the sensors as described above are fed to the electronic control unit ECU. Thus, the hydraulic braking pressure discharged from the master cylinder MC, the hydraulic braking pressure in the wheel brake cylinder WC and the stroke of the brake pedal BP are monitored by those sensors. Furthermore, in order to achieve those controls including an anti-skid control or the like, sensors SN such as wheel speed sensors, acceleration sensor or the like have been provided, so that the signals detected by them are fed to the electronic control unit ECU.

Hereinafter, explained is operation of the hydraulic brake apparatus having the master cylinder MC with the braking stroke simulator SM as constituted above. At the outset, when the pressure control device PC is normal, the switching valve NO is energized to be placed in its closed position, so that the communication between the master cylinder MC and the wheel brake cylinder WC is blocked, and the hydraulic pressure discharged from the master cylinder MC is supplied to the wheel brake cylinder WC in response to operation of the brake pedal BP, on the basis of the value detected by the stroke sensor BS and the pressure sensor Smc. That is, the electric current fed to the first and second linear solenoid valves SV1 and SV2 is controlled respectively, so that the wheel cylinder pressure detected by the pressure sensor Swc equals to a desired wheel cylinder pressure. Consequently, the hydraulic pressure controlled by the pressure control device PC in response to operation of the brake pedal BP is supplied to the wheel brake cylinder WC.

In the case where the pressure control device PC is normal as described above, according to the master cylinder MC, the master piston MP is not advanced substantially from such a position that the communication between the master pressure chamber C1 and the atmospheric pressure chamber C2 is blocked, i.e., the position advanced from the initial position of the master piston MP by the first stroke (D1). Therefore, the simulator chamber C4 is communicated with the atmospheric pressure chamber C2 and finally with the reservoir RS, through the clearance CL between the seal member S2 and the annular groove G2 formed in the housing HS, so that the simulator chamber C4 is under the atmospheric pressure. Accordingly, if the braking operation force applied to the simulator piston SP becomes equal to or greater than a compressive force for mounting the compression spring E2 in the stroke simulator SM, the compression spring E2 is compressed to provide the stroke of the simulator piston SP in response to the braking operation force. As a result, the stroke of the brake pedal BP is provided in response to the braking operation force.

On the contrary, in the case where the pressure control device PC including the pressure source PG and the like comes to be abnormal, the switching valve NO is de-energized (turned off) to be placed in its open position, so that the master cylinder MC and the wheel brake cylinder WC are communicated with each other, as shown in FIG. 2. At the same time, the first and second linear solenoid valves SV1 and SV2 are de-energized (turned off) to be placed in their closed positions, respectively, so that the hydraulic pressure is not supplied from the pressure source PG to the wheel brake cylinder WC. In this state, therefore, when the brake pedal BP is depressed, to advance the master piston MP by the second stroke (D2) or more from the initial position in response to operation of the brake pedal BP, the seal member S2 will contact the large diameter bore B3 formed in the housing HS, to block the communication between the simulator chamber C4 and the atmospheric pressure chamber C2. Hereafter, therefore, the master piston MP will be advanced, without the compression spring E2 being compressed in response to operation of the brake pedal BP, to discharge the hydraulic pressure from the master pressure chamber C1 to the wheel brake cylinder WC.

In this case, even in such a state that the communication between the simulator chamber C4 and the atmospheric pressure chamber C2 is blocked, with the master piston MP being advanced, if the pressure control device PC comes to be abnormal during the operation of the brake pedal BP, i.e., when the stroke simulator SM is being stroked, the stroke simulator SM will be immediately retracted to its initial position by releasing the brake pedal BP to communicate the simulator chamber C4 with the atmospheric pressure chamber C2 through the seal member S2 with its function as a check valve. In other words, the position of the simulator piston SP relative to the position of the master piston MP is placed to be in its initial position. Therefore, a so-called dead stroke could be prevented effectively, even if the brake pedal BP was operated more. Also, even if the brake pedal BP was rapidly released from such a state that the communication between the simulator chamber C4 and the atmospheric pressure chamber C2 was blocked, the simulator piston SP could only be moved rearward up to the position where it would contact the C-ring CR. In other words, as the retracting operation of the simulator piston SP is restricted by the C-ring CR at the rearmost position of the simulator piston SP to be determined relative to the master piston MP when the brake pedal BP has not been depressed, the master piston MP will not be prevented from being moved rearward. Therefore, the master piston MP could be moved rearward until its rear end will contact the stopper NH, so that the master pressure chamber C1 could be definitely opened to communicate with the reservoir RS.

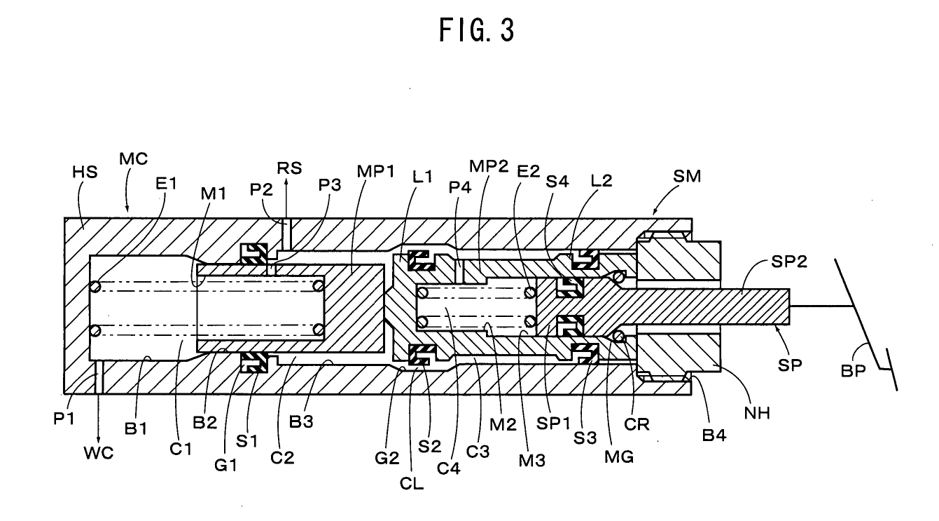

Next, another embodiment of the present invention is explained referring to FIG. 3, wherein structural elements equivalent to those describe in FIG. 1 are designated by corresponding reference numerals. According to the present embodiment, the master piston MP as shown in FIG. 1 is divided into two sections of a master piston MP1 and an auxiliary piston MP2, in a rear end portion of which there is defined the large diameter bore M3 for receiving therein the simulator piston SP. In the same manner as in the aforementioned embodiment, therefore, the C-ring CR is fitted into the annular groove MG of the auxiliary piston MP2 in such a state that the piston portion SP1 of the simulator piston SP is received in the large diameter bore M3, so that the rearmost position of the simulator piston SP relative to the auxiliary piston MP2 is defined.

According to the embodiment as shown in FIG. 3, when the master piston MP1 and auxiliary piston MP2 are placed in their initial positions, respectively, the simulator chamber C4 is communicated with the atmospheric pressure chamber C2 through the clearance CL, and if the master piston MP1 and auxiliary piston MP2 are advanced from the initial positions by the second stroke (D2) or more, the communication between the simulator chamber C4 and the atmospheric pressure chamber C2 will be blocked. Then, even if the brake pedal BP was rapidly released from the blocked state, as the retracting operation of the simulator piston SP relative to the auxiliary piston MP2 is restricted by the C-ring CR, the auxiliary piston MP2 could be moved rearward until its rear end will contact the stopper NH. Therefore, the master piston MP1 and auxiliary piston MP2 could be moved rearward until their initial positions, respectively, to open the master pressure chamber C1 definitely.

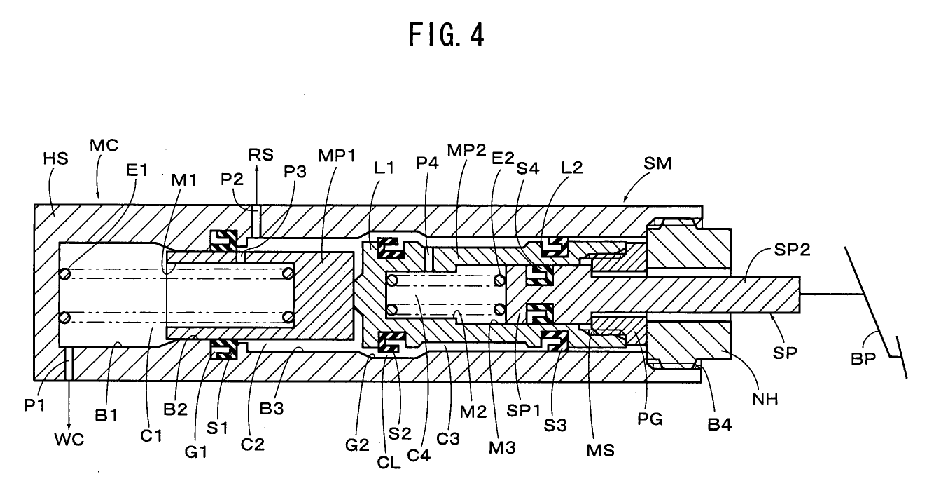

FIG. 4 illustrates a further embodiment of the present invention, wherein structural elements equivalent to those as shown in FIG. 3 are designated by corresponding reference numerals. According to the present embodiment, as for the blocking member, an annular plug PG is screwed into the rear end recess of the auxiliary piston MP2, and the stopper NH is fixed to contact the plug PG. Instead of the threaded plug PG, an annular stopper ST as shown in FIG. 6 may be pressed into the recess.

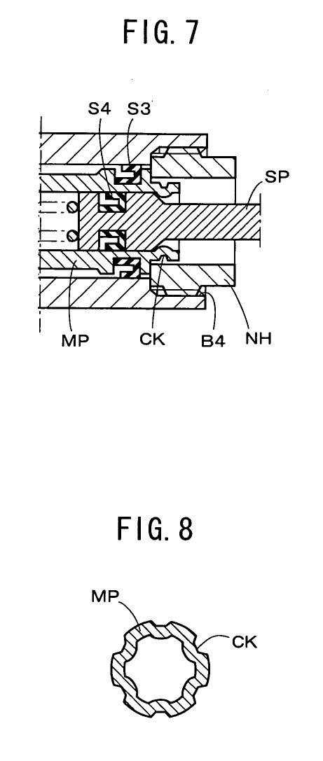

FIGS. 7 and 8 relate to a further embodiment of the blocking member, which includes a caulking portion CK formed on a rear end portion of the master piston MP, or the auxiliary piston MP2 as shown in FIG. 3, to define the rearmost position of the simulator piston SP relative to the master piston MP or the auxiliary piston MP2. Instead of the threaded plug PG, an annular stopper ST as shown in FIG. 6 may be pressed into the recess. According to the embodiments as described above, the master cylinder MC may be formed to provide a tandem master cylinder having a couple of master pressure chambers.

It should be apparent to one skilled in the art that the above-described embodiments are merely illustrative of but one of the many possible specific embodiments of the present invention. Numerous and various other arrangements can be readily devised by those skilled in the art without departing from the spirit and scope of the invention as defined in the following claims.

1. A master cylinder with a braking stroke simulator operated in response to operation of a manually operated braking member, comprising:
a piston member slidably accommodated in a cylinder bore of a cylinder housing for defining a master pressure chamber in front of said piston member;
a stroke simulator having a simulator piston for defining a simulator chamber in front of said simulator piston and moving back and forth in response to operation of said manually operated braking member, to communicate said master pressure chamber with an atmospheric pressure chamber when said piston member is placed in an initial position thereof, and block the communication between said master pressure chamber and said atmospheric pressure chamber when said piston member is advanced from the initial position thereof by a first stroke or more, and said stroke simulator having an elastic member for applying a stroke of said simulator piston in response to braking operation force of said manually operated braking member, said stroke simulator transmitting the braking operation force of said manually operated braking member to said piston member, through said simulator piston and said elastic member;
communication control means for communicating said simulator chamber with said atmospheric pressure chamber when said piston member is placed in an initial position thereof, and blocking the communication between said simulator chamber and said atmospheric pressure chamber when said piston member is advanced from the initial position thereof by a second stroke or more, the second stroke being set to be greater than the first stroke; and
restriction means for restricting said simulator piston to be retracted up to a position thereof which is placed relative to said piston member when said manually operated braking member is inoperative.

2. A master cylinder with a braking stroke simulator as set forth in claim 1, wherein said piston member includes a master piston slidably received in said cylinder bore for defining said master pressure chamber in front of said master piston,
and wherein said master piston has a recess being formed to be opened rearward of said master piston, and accommodating said elastic member and said simulator piston in said recess.

3. A master cylinder with a braking stroke simulator as set forth in claim 2, wherein said restriction means includes a blocking member fixed on a rear end portion of the recess of said master piston to prevent said simulator piston from being moved rearward beyond said blocking member.

4. A master cylinder with a braking stroke simulator as set forth in claim 3, wherein said master piston has an annular groove formed on an inner peripheral surface of the rear end portion of the recess of said master piston,
and wherein said blocking member is a ring member formed in C-shape and fitted into the annular groove formed on the recess of said master piston.

5. A master cylinder with a braking stroke simulator as set forth in claim 3, wherein said blocking member is an annular plug screwed into the rear end portion of the recess of said master piston.

6. A master cylinder with a braking stroke simulator as set forth in claim 3, wherein said blocking member is an annular stopper pressed into the rear end portion of the recess of said master piston.

7. A master cylinder with a braking stroke simulator as set forth in claim 3, wherein said blocking member is a caulking portion formed on the rear end portion of the recess of said master piston.

8. A master cylinder with a braking stroke simulator as set forth in claim 1, wherein said piston member includes a master piston slidably received in said cylinder bore for defining said master pressure chamber in front of said master piston, and an auxiliary piston placed to be in contact with a rear end face of said master piston and formed with a recess being opened rearward of said auxiliary piston, to accommodate therein said elastic member and said simulator piston,
wherein said communication control means blocks the communication between said simulator chamber and said atmospheric pressure chamber when said auxiliary piston is advanced from the initial position thereof by the second stroke or more,
and wherein said restriction means restricts said simulator piston to be retracted up to a position thereof which is placed relative to said auxiliary piston when said manually operated braking member is inoperative.

9. A master cylinder with a braking stroke simulator as set forth in claim 8, wherein said restriction means includes a blocking member fixed on a rear end portion of the recess of said auxiliary piston to prevent said simulator piston from being moved rearward beyond said blocking member.

10. A master cylinder with a braking stroke simulator as set forth in claim 9, wherein said auxiliary piston has an annular groove formed on an inner peripheral surface of the rear end portion of the recess of said auxiliary piston,
and wherein said blocking member is a ring member formed in C-shape and fitted into the annular groove formed on the recess of said auxiliary piston.

11. A master cylinder with a braking stroke simulator as set forth in claim 9, wherein said blocking member is an annular plug screwed into the rear end portion of the recess of said auxiliary piston.

12. A master cylinder with a braking stroke simulator as set forth in claim 9, wherein said blocking member is an annular stopper pressed into the rear end portion of the recess of said auxiliary piston.

13. A master cylinder with a braking stroke simulator as set forth in claim 9, wherein said blocking member is a caulking portion formed on the rear end portion of the recess of said auxiliary piston.
